(19) United States
(12) Patent Application Publication
(10) Pub. No.: US 2019/0359222 A1
(43) Pub. Date: Nov. 28, 2019

(54) CONTINGENCY PLAN SYSTEM AND METHOD

(71) Applicant: Optimus Ride, Inc., Boston, MA (US)

(72) Inventors: Albert Huang, Sunnyvale, CA (US); Sertac Karaman, Cambridge, MA (US); Ryan C. C. Chin, Boston, MA (US); Jenny Larios Berlin, Chestnut Hill, MA (US); Ramiro Almeida, Key Biscayne, FL (US); Ruijie He, Boston, MA (US); Patrick Barragan, Cambridge, MA (US); John Sgueglia, Cambridge, MA (US); Matthew Dunlap, Boston, MA (US)

(21) Appl. No.: 16/419,667

(22) Filed: May 22, 2019

Related U.S. Application Data
(60) Provisional application No. 62/675,419, filed on May 23, 2018.

(51) Int. Cl. B60W 50/02; G05D 1/00; B60W 50/04

(52) U.S. Cl. CPC B60W 50/0225; G05D 1/0088; B60W 50/0205; B60W 2900/00; G05D 2201/0213; B60W 2400/00; B60W 50/045

(57) ABSTRACT

A method, computer program product, and computing system for monitoring the operating environment of an autonomous vehicle to generate one or more initial usage values; and calculating an initial failure contingency plan based, at least in part, upon the one or more initial usage values.

### RELATED APPLICATION(S)

This application claims the benefit of U.S. Provisional Application No. 62/675,419, filed on 23 May 2018, the entire contents of which are incorporated herein by reference.

### TECHNICAL FIELD

This disclosure relates to failure contingency plans and, more particularly, to failure contingency plans for use in autonomous vehicles.

### BACKGROUND

As transportation moves towards autonomous (i.e., driverless) vehicles, the manufactures and designers of these autonomous vehicle must define contingencies that occur in the event of a failure of one or more of the systems within these autonomous vehicles.

As is known, autonomous vehicles contain multiple electronic control units (ECUs), wherein each of these ECUs may perform a specific function. For example, these various ECUs may calculate safe trajectories for the vehicle (e.g., for navigating the vehicle to its intended destination) and may provide control signals to the vehicle's actuators, propulsions systems and braking systems. Typically, one ECU (e.g., an Autonomy Control Unit) may be responsible for planning and calculating a trajectory for the vehicle, and may provide commands to other ECUs that may cause the vehicle to move (e.g., by controlling steering, braking, and powertrain ECUs).

Unfortunately, it is possible for the Autonomy Control Unit to fail; or for communication between the Autonomy Control Unit and one or more of the other ECUs in the vehicle to fail. In either case and as long as the other ECUs are functioning, it may be desirable for the functioning ECUs to bring the vehicle to a safe stop if possible. This may be accomplished by having the functioning ECUs execute simple pre-programmed procedures (e.g., to apply moderate braking pressure to bring the vehicle to a halt). However and depending on the exact traffic scenario, such procedures may not be the safest course of action.

### SUMMARY OF DISCLOSURE

In one implementation, a computer-implemented method is executed on a computing device and includes: monitoring the operating environment of an autonomous vehicle to generate one or more initial usage values; and calculating an initial failure contingency plan based, at least in part, upon the one or more initial usage values.

One or more of the following features may be included. Monitoring the operating environment of an autonomous vehicle to generate one or more initial usage values may include monitoring the status of one or more sensors included within the autonomous vehicle to generate the one or more initial usage values. A failure of at least a portion of the autonomous vehicle may be sensed. The initial failure contingency plan may be executed in response to sensing the failure. The initial failure contingency plan may include one or more of: a cease operation portion configured to provide an orderly shutdown of the autonomous vehicle when the failure sensed is a major failure; and a degraded operation portion configured to allow degraded operation of the autonomous vehicle when the failure sensed is a minor failure. The operating environment of an autonomous vehicle may be monitored to generate one or more updated usage values. An updated failure contingency plan may be calculated based, at least in part, upon the one or more updated usage values. Monitoring the operating environment of an autonomous vehicle to generate one or more updated usage values may include monitoring the status of one or more sensors included within the autonomous vehicle to generate the one or more updated usage values. A failure of at least a portion of the autonomous vehicle may be sensed. The updated failure contingency plan may be executed in response to sensing the failure. The updated failure contingency plan may include one or more of: a cease operation portion configured to provide an orderly shutdown of the autonomous vehicle when the failure sensed is a major failure; and a degraded operation portion configured to allow degraded operation of the autonomous vehicle when the failure sensed is a minor failure. Monitoring the operating environment of an autonomous vehicle to generate one or more updated usage values may include iteratively monitoring, at defined intervals, the operating environment of an autonomous vehicle to iteratively generate one or more updated usage values. Calculating an updated failure contingency plan based, at least in part, upon the one or more updated usage values may include iteratively calculating, at defined intervals, the updated failure contingency plan based, at least in part, upon the one or more updated usage values.

In another implementation, a computer program product resides on a computer readable medium and has a plurality of instructions stored on it. When executed by a processor, the instructions cause the processor to perform operations including monitoring the operating environment of an autonomous vehicle to generate one or more initial usage values; and calculating an initial failure contingency plan based, at least in part, upon the one or more initial usage values.

One or more of the following features may be included. Monitoring the operating environment of an autonomous vehicle to generate one or more initial usage values may include monitoring the status of one or more sensors included within the autonomous vehicle to generate the one or more initial usage values. A failure of at least a portion of the autonomous vehicle may be sensed. The initial failure contingency plan may be executed in response to sensing the failure. The initial failure contingency plan may include one or more of: a cease operation portion configured to provide an orderly shutdown of the autonomous vehicle when the failure sensed is a major failure; and a degraded operation portion configured to allow degraded operation of the autonomous vehicle when the failure sensed is a minor failure. The operating environment of an autonomous vehicle may be monitored to generate one or more updated usage values. An updated failure contingency plan may be calculated based, at least in part, upon the one or more updated usage values. Monitoring the operating environment of an autonomous vehicle to generate one or more updated usage values may include monitoring the status of one or more sensors included within the autonomous vehicle to generate the one or more updated usage values. A failure of at least a portion of the autonomous vehicle may be sensed. The updated failure contingency plan may be executed in response to sensing the failure. The updated failure contingency plan may include one or more of: a cease operation portion configured to provide an orderly shutdown of the autonomous vehicle when the failure sensed is a major failure; and a degraded operation portion configured to allow degraded operation of the autonomous vehicle when the failure sensed is a minor failure. Monitoring the operating environment of an autonomous vehicle to generate one or more updated usage values may include iteratively monitoring, at defined intervals, the operating environment of an autonomous vehicle to iteratively generate one or more updated usage values. Calculating an updated failure contingency plan based, at least in part, upon the one or more updated usage values may include iteratively calculating, at defined intervals, the updated failure contingency plan based, at least in part, upon the one or more updated usage values.

In another implementation, a computing system includes a processor and memory is configured to perform operations including monitoring the operating environment of an autonomous vehicle to generate one or more initial usage values; and calculating an initial failure contingency plan based, at least in part, upon the one or more initial usage values.

One or more of the following features may be included. Monitoring the operating environment of an autonomous vehicle to generate one or more initial usage values may include monitoring the status of one or more sensors included within the autonomous vehicle to generate the one or more initial usage values. A failure of at least a portion of the autonomous vehicle may be sensed. The initial failure contingency plan may be executed in response to sensing the failure. The initial failure contingency plan may include one or more of: a cease operation portion configured to provide an orderly shutdown of the autonomous vehicle when the failure sensed is a major failure; and a degraded operation portion configured to allow degraded operation of the autonomous vehicle when the failure sensed is a minor failure. The operating environment of an autonomous vehicle may be monitored to generate one or more updated usage values. An updated failure contingency plan may be calculated based, at least in part, upon the one or more updated usage values. Monitoring the operating environment of an autonomous vehicle to generate one or more updated usage values may include monitoring the status of one or more sensors included within the autonomous vehicle to generate the one or more updated usage values. A failure of at least a portion of the autonomous vehicle may be sensed. The updated failure contingency plan may be executed in response to sensing the failure. The updated failure contingency plan may include one or more of: a cease operation portion configured to provide an orderly shutdown of the autonomous vehicle when the failure sensed is a major failure; and a degraded operation portion configured to allow degraded operation of the autonomous vehicle when the failure sensed is a minor failure. Monitoring the operating environment of an autonomous vehicle to generate one or more updated usage values may include iteratively monitoring, at defined intervals, the operating environment of an autonomous vehicle to iteratively generate one or more updated usage values. Calculating an updated failure contingency plan based, at least in part, upon the one or more updated usage values may include iteratively calculating, at defined intervals, the updated failure contingency plan based, at least in part, upon the one or more updated usage values.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an autonomous vehicle according to an embodiment of the present disclosure;

FIG. 2A is a diagrammatic view of one embodiment of the various systems included within the autonomous vehicle of FIG. 1 according to an embodiment of the present disclosure;

FIG. 2B is a diagrammatic view of another embodiment of the various systems included within the autonomous vehicle of FIG. 1 according to an embodiment of the present disclosure;

FIG. 3 is a diagrammatic view of another embodiment of the various systems included within the autonomous vehicle of FIG. 1 according to an embodiment of the present disclosure;

FIG. 4 is a flowchart of a contingency plan process executed on one or more systems of the autonomous vehicle of FIG. 1 according to an embodiment of the present disclosure; and

FIG. 5 is a diagrammatic view of a failure contingency plan calculated by the contingency plan process of FIG. 4 according to an embodiment of the present disclosure.

Like reference symbols in the various drawings indicate like elements.

### DETAILED DESCRIPTION OF THE PREFERRED EMBODIMENTS

Autonomous Vehicle Overview

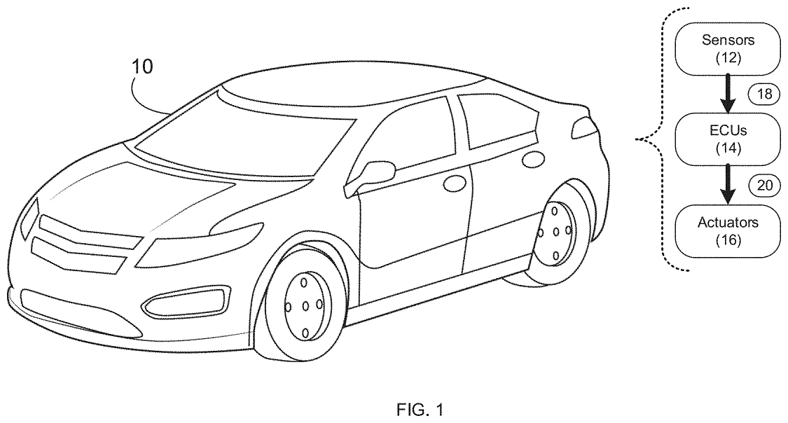

Referring to FIG. 1, there is shown autonomous vehicle 10. As is known in the art, an autonomous vehicle (e.g. autonomous vehicle 10) is a vehicle that is capable of sensing its environment and moving with little or no human input. Autonomous vehicles (e.g. autonomous vehicle 10) may combine a variety of sensor systems to perceive their surroundings, examples of which may include but are not limited to radar, computer vision, LIDAR, GPS, odometry, temperature and interial, wherein such sensor systems may be configured to interpret lanes and markings on a roadway, street signs, stoplights, pedestrians, other vehicles, roadside objects, hazards, etc.

Autonomous vehicle 10 may include a plurality of sensors (e.g. sensors 12), a plurality of electronic control units (e.g. ECUs 14) and a plurality of actuators (e.g. actuators 16). Accordingly, sensors 12 within autonomous vehicle 10 may monitor the environment in which autonomous vehicle 10 is operating, wherein sensors 12 may provide sensor data 18 to ECUs 14. ECUs 14 may process sensor data 18 to determine the manner in which autonomous vehicle 10 should move. ECUs 14 may then provide control data 20 to actuators 16 so that autonomous vehicle 10 may move in the manner decided by ECUs 14. For example, a machine vision sensor included within sensors 12 may “read” a speed limit sign stating that the speed limit on the road on which autonomous vehicle 10 is traveling is now 35 miles an hour. This machine vision sensor included within sensors 12 may provide sensor data 18 to ECUs 14 indicating that the speed on the road on which autonomous vehicle 10 is traveling is now 35 mph. Upon receiving sensor data 18, ECUs 14 may process sensor data 18 and may determine that autonomous vehicle 10 (which is currently traveling at 45 mph) is traveling too fast and needs to slow down. Accordingly, ECUs 14 may provide control data 20 to actuators 16, wherein control data 20 may e.g. apply the brakes of autonomous vehicle 10 or eliminate any actuation signal currently being applied to the accelerator (thus allowing autonomous vehicle 10 to coast until the speed of autonomous vehicle 10 is reduced to 35 mph).

System Redundancy

As would be imagined, since autonomous vehicle 10 is being controlled by the various electronic systems included therein (e.g. sensors 12, ECUs 14 and actuators 16), the potential failure of one or more of these systems should be considered when designing autonomous vehicle 10 and appropriate contingency plans may be employed.

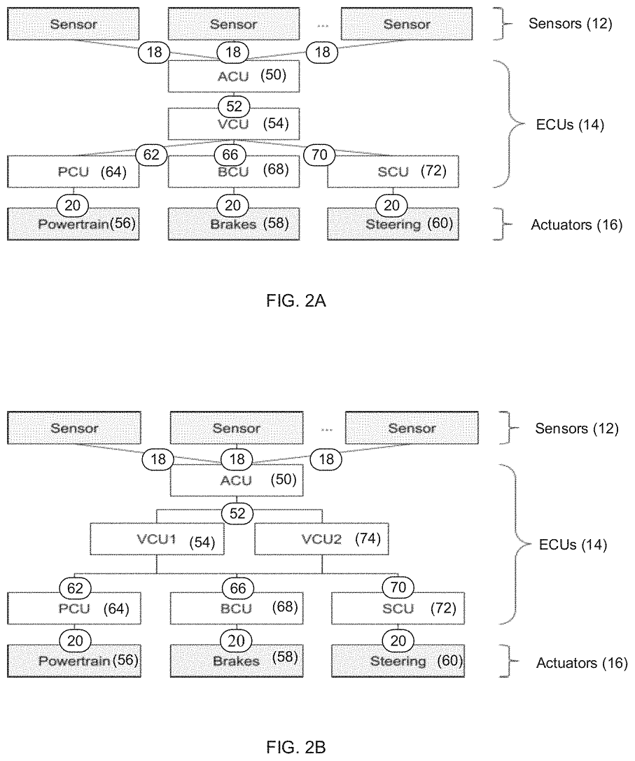

For example and referring also to FIG. 2A, the various ECUs (e.g., ECUs 14) that are included within autonomous vehicle 10 may be compartmentalized so that the responsibilities of the various ECUs (e.g., ECUs 14) may be logically grouped. For example, ECUs 14 may include autonomy control unit 50 that may receive sensor data 18 from sensors 12.

Autonomy control unit 50 may be configured to perform various functions. For example, autonomy control unit 50 may receive and process exteroceptive sensor data (e.g., sensor data 18), may estimates the position of autonomous vehicle 10 within its operating environment, may calculate a representation of the surroundings of autonomous vehicle 10, may compute safe trajectories for autonomous vehicle 10, and may command the other ECUs (in particular, a vehicle control unit) to cause autonomous vehicle 10 to execute a desired maneuver. Autonomy control unit 50 may include substantial compute power, persistent storage, and memory.

Accordingly, autonomy control unit 50 may process sensor data 18 to determine the manner in which autonomous vehicle 10 should be operating. Autonomy control unit 50 may then provide vehicle control data 52 to vehicle control unit 54, wherein vehicle control unit 54 may then process vehicle control data 52 to determine the manner in which the individual control systems (e.g. powertrain system 56, braking system 58 and steering system 60) should respond in order to achieve the trajectory defined by autonomous control unit 50 within vehicle control data 52.

Vehicle control unit 54 may be configured to control other ECUs included within autonomous vehicle 10. For example, vehicle control unit 54 may control the steering, powertrain, and brake controller units. For example, vehicle control unit 54 may provide: powertrain control signal 62 to powertrain control unit 64; braking control signal 66 to braking control unit 68; and steering control signal 70 to steering control unit 72.

Powertrain control unit 64 may process powertrain control signal 62 so that the appropriate control data (commonly represented by control data 20) may be provided to powertrain system 56. Additionally, braking control unit 68 may process braking control signal 66 so that the appropriate control data (commonly represented by control data 20) may be provided to braking system 58. Further, steering control unit 72 may process steering control signal 70 so that the appropriate control data (commonly represented by control data 20) may be provided to steering system 60.

Powertrain control unit 64 may be configured to control the transmission (not shown) and engine/traction motor (not shown) within autonomous vehicle 10; while brake control unit 68 may be configured to control the mechanical/regenerative braking system (not shown) within autonomous vehicle 10; and steering control unit 72 may be configured to control the steering column/steering rack (not shown) within autonomous vehicle 10.

Autonomy control unit 50 may be a highly complex computing system that may provide extensive processing capabilities (e.g., a workstation-class computing system with multi-core processors, discrete co-processing units, gigabytes of memory, and persistent storage). In contrast, vehicle control unit 54 may be a much simpler device that may provide processing power equivalent to the other ECUs included within autonomous vehicle 10 (e.g., a computing system having a modest microprocessor (with a CPU frequency of less than 200 megahertz), less than 1 megabyte of system memory, and no persistent storage). Due to these simpler designs, vehicle control unit 54 may have greater reliability and durability than autonomy control unit 50.

To further enhance redundancy and reliability, one or more of the ECUs (ECUs 14) included within autonomous vehicle 10 may be configured in a redundant fashion. For example in referring also to FIG. 2B, there is shown one implementation of ECUs 14 wherein a plurality of vehicle control units are utilized. For example, this particular implementation is shown to include two vehicle control units, namely a first vehicle control unit (e.g., vehicle control unit 54) and a second vehicle control unit (e.g., vehicle control unit 74).

In this particular configuration, the two vehicle control units (e.g. vehicle control units 54, 74) may be configured in various ways. For example, the two vehicle control units (e.g. vehicle control units 54, 74) may be configured in an active—passive configuration, wherein e.g. vehicle control unit 54 performs the active role of processing vehicle control data 52 while vehicle control unit 74 assumes a passive role and is essentially in standby mode. In the event of a failure of vehicle control unit 54, vehicle control unit 74 may transition from a passive role to an active role and assume the role of processing vehicle control data 52. Alternatively, the two vehicle control units (e.g. vehicle control units 54, 74) may be configured in an active—active configuration, wherein e.g. both vehicle control unit 52 and vehicle control unit 74 perform the active role of processing vehicle control data 54 (e.g. divvying up the workload), wherein in the event of a failure of either vehicle control unit 54 or vehicle control unit 74, the surviving vehicle control unit may process all of vehicle control data 52.

While FIG. 2B illustrates one example of the manner in which the various ECUs (e.g. ECUs 14) included within autonomous vehicle 10 may be configured in a redundant fashion, this is for illustrative purposes only and is not intended to be a limitation of this disclosure, as other configurations are possible and are considered to be within the scope of this disclosure. For example, autonomous control unit 50 may be configured in a redundant fashion, wherein a second autonomous control unit (not shown) is included within autonomous vehicle 10 and is configured in an active—passive or active—active fashion. Further, it is foreseeable that one or more of the sensors (e.g., sensors 12) and/or one or more of the actuators (e.g. actuators 16) may be configured in a redundant fashion. Accordingly, it is understood that the level of redundancy achievable with respect to autonomous vehicle 10 may only be limited by the design criteria and budget constraints of autonomous vehicle 10.

Autonomy Computational Subsystems

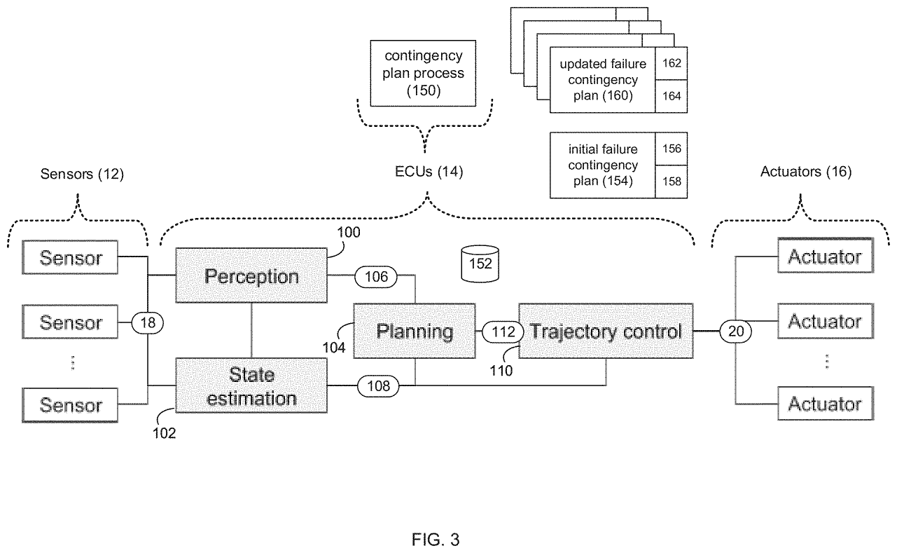

Referring also to FIG. 3, the various ECUs of autonomous vehicle 10 may be grouped/arranged/configured to effectuate various functionalities.

For example, one or more of ECUs 14 may be configured to effectuate/form perception subsystem 100. wherein perception subsystem 100 may be configured to process data from onboard sensors (e.g., sensor data 18) to calculate concise representations of objects of interest near autonomous vehicle 10 (examples of which may include but are not limited to other vehicles, pedestrians, traffic signals, traffic signs, road markers, hazards, etc.) and to identify environmental features that may assist in determining the location of autonomous vehicle 10. Further, one or more of ECUs 14 may be configured to effectuate/form state estimation subsystem 102, wherein state estimation subsystem 102 may be configured to process data from onboard sensors (e.g., sensor data 18) to estimate the position, orientation, and velocity of autonomous vehicle 10 within its operating environment. Additionally, one or more of ECUs 14 may be configured to effectuate/form planning subsystem 104, wherein planning subsystem 104 may be configured to calculate a desired vehicle trajectory (using perception output 106 and state estimation output 108). Further still, one or more of ECUs 14 may be configured to effectuate/form trajectory control subsystem 110, wherein trajectory control subsystem 110 uses planning output 112 and state estimation output 108 (in conjunction with feedback and/or feedforward control techniques) to calculate actuator commands (e.g., control data 20) that may cause autonomous vehicle 10 to execute its intended trajectory within it operating environment.

For redundancy purposes, the above-described subsystems may be distributed across various devices (e.g., autonomy control unit 50 and vehicle control units 54, 74). Additionally/alternatively and due to the increased computational requirements, perception subsystem 100 and planning subsystem 104 may be located almost entirely within autonomy control unit 50, which (as discussed above) has much more computational horsepower than vehicle control units 54, 74. Conversely and due to their lower computational requirements, state estimation subsystem 102 and trajectory control subsystem 110 may be: located entirely on vehicle control units 54, 74 if vehicle control units 54, 74 have the requisite computational capacity; and/or located partially on vehicle control units 54, 74 and partially on autonomy control unit 50. However, the location of state estimation subsystem 102 and trajectory control subsystem 110 may be of critical importance in the design of any contingency planning architecture, as the location of these subsystems may determine how contingency plans are calculated, transmitted, and/or executed.

Trajectory Calculation

During typical operation of autonomous vehicle 10, the autonomy subsystems described above repeatedly perform the following functionalities of:
Measuring the surrounding environment using on-board sensors (e.g. using sensors 12);
Estimating the positions, velocities, and future trajectories of surrounding vehicles, pedestrians, cyclists, other objects near autonomous vehicle 10, and environmental features useful for location determination (e.g., using perception subsystem 100);
Estimating the position, orientation, and velocity of autonomous vehicle 10 within the operating environment (e.g., using state estimation subsystem 102);
Planning a nominal trajectory for autonomous vehicle 10 to follow that brings autonomous vehicle 10 closer to the intended destination of autonomous vehicle 10 (e.g., using planning subsystem 104); and
Generating commands (e.g., control data 20) to cause autonomous vehicle 10 to execute the intended trajectory (e.g., using trajectory control subsystem 110)

During each iteration, planning subsystem 104 may calculate a trajectory that may span travel of many meters (in distance) and many seconds (in time). However, each iteration of the above-described loop may be calculated much more frequently (e.g., every ten milliseconds). Accordingly, autonomous vehicle 10 may be expected to execute only a small portion of each planned trajectory before a new trajectory is calculated (which may differ from the previously-calculated trajectories due to e.g., sensed environmental changes).

Trajectory Execution

The above-described trajectory may be represented as a parametric curve that describes the desired future path of autonomous vehicle 10. There may be two major classes of techniques for controlling autonomous vehicle 10 while executing the above-described trajectory: a) feedforward control and b) feedback control.

Under nominal conditions, a trajectory is executed using feedback control, wherein feedback trajectory control algorithms may use e.g., a kinodynamic model of autonomous vehicle 10, per-vehicle configuration parameters, and a continuously-calculated estimate of the position, orientation, and velocity of autonomous vehicle 10 to calculate the commands that are provided to the various ECUs included within autonomous vehicle 10.

Feedforward trajectory control algorithms may use a kinodynamic model of autonomous vehicle 10, per-vehicle configuration parameters, and a single estimate of the initial position, orientation, and velocity of autonomous vehicle 10 to calculate a sequence of commands that are provided to the various ECUs included within autonomous vehicle 10, wherein the sequence of commands are executed without using any real-time sensor data (e.g. from sensors 12) or other information.

To execute the above-described trajectories, autonomy control unit 50 may communicate with (and may provide commands to) the various ECUs, using vehicle control unit 54/74 as an intermediary. At each iteration of the above-described trajectory execution loop, autonomy control unit 50 may calculate steering, powertrain, and brake commands that are provided to their respective ECUs (e.g., powertrain control unit 64, braking control unit 68, and steering control unit 72; respectively), and may transmit these commands to vehicle control unit 54/74. Vehicle control unit 54/74 may then validate these commands and may relay them to the various ECUs (e.g., powertrain control unit 64, braking control unit 68, and steering control unit 72; respectively).

Real-Time Contingency Planning

As discussed above, since autonomous vehicle 10 is being controlled by the various electronic systems included therein (e.g. sensors 12, ECUs 14 and actuators 16), the potential failure of one or more of these systems should be considered when designing autonomous vehicle 10 and appropriate contingency plans may be employed. Further and as discussed above, to enhance redundancy and reliability, one or more of the ECUs (e.g., ECUs 14) included within autonomous vehicle 10 may be configured in a redundant fashion.

In order to provide a high level of redundancy, one or more of ECUs 14 may execute contingency plan process 150. Contingency plan process 150 may be executed on a single ECU or may be executed collaboratively across multiple ECUs. For example, contingency plan process 150 may be executed solely by autonomy control unit 50, vehicle control unit 54 or vehicle control unit 74. Alternatively, contingency plan process 150 may be executed collaboratively across the combination of autonomy control unit 50, vehicle control unit 54 and vehicle control unit 74. Accordingly and in the latter configuration, in the event of a failure of one of autonomy control unit 50, vehicle control unit 54 or vehicle control unit 74, the surviving control unit(s) may continue to execute contingency plan process 150.

The instruction sets and subroutines of contingency plan process 150, which may be stored on storage device 152 coupled to ECUs 14, may be executed by one or more processors (not shown) and one or more memory architectures (not shown) included within ECUs 14. Examples of storage device 152 may include but are not limited to: a hard disk drive; a RAID device; a random access memory (RAM); a read-only memory (ROM); and all forms of flash memory storage devices.

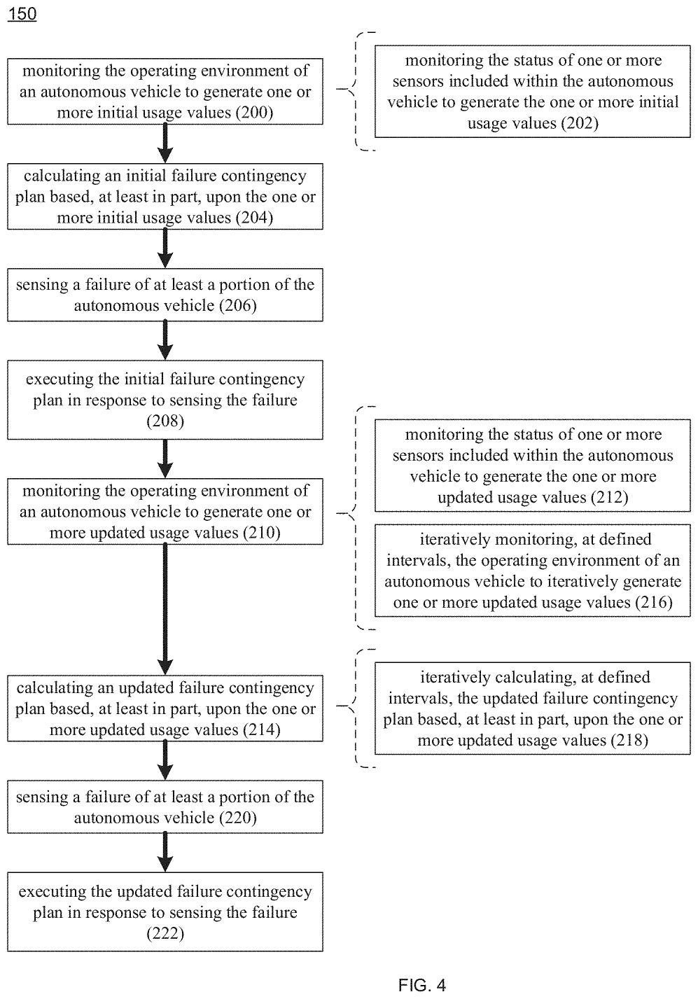

Referring also to FIG. 4, contingency plan process 150 may monitor 200 the operating environment of autonomous vehicle 10 to generate one or more initial usage values. For example and when monitoring 200 the operating environment of autonomous vehicle 10 to generate one or more initial usage values, contingency plan process 150 may monitor 202 the status of one or more sensors (e.g., sensors 12) included within autonomous vehicle 10 to generate the one or more initial usage values (e.g., sensor data 18). As discussed above, autonomous vehicle 10 may combine a variety of sensor systems (e.g., sensors 12) to perceive the surroundings of autonomous vehicle 10, examples of which may include but are not limited to radar, computer vision, LIDAR, GPS, odometry, temperature and interial, wherein such sensor systems (e.g., sensors 12) may be configured to interpret lanes and markings on a roadway, street signs, stoplights, pedestrians, other vehicles, roadside objects, hazards, etc.

Once the above-described initial usage values (e.g., sensor data 18) are generated, contingency plan process 150 may calculate 204 an initial failure contingency plan (e.g., failure contingency plan 154) based, at least in part, upon the one or more initial usage values (e.g., sensor data 18). Specifically, contingency plan process 150 may monitor 202 sensors 12 included within autonomous vehicle 10 to generate sensor data 18 to determine the operating environment of autonomous vehicle 10 so that contingency plan process 150 is aware of the surrounding of autonomous vehicle 10.

For example and when a person is driving a traditional vehicle, the driver will stay aware of their surroundings so that e.g., in the event that someone swerves into their lane, the driver knows that e.g., the lane to their right is empty so that they can quickly move into that lane to avoid an accident. Accordingly, contingency plan process 150 may monitor 202 sensor data 18 so that contingency plan process 150 is aware of the surrounding of autonomous vehicle 10, thus allowing contingency plan process 150 to calculate 204 an initial failure contingency plan (e.g., failure contingency plan 154) based, at least in part, upon sensor data 18.

Initial failure contingency plan 154 may include one or more of: cease operation portion 156 configured to provide an orderly shutdown of autonomous vehicle 10 when the failure sensed is a major failure; and degraded operation portion 158 configured to allow degraded operation of autonomous vehicle 10 when the failure sensed is a minor failure.

In the event that contingency plan process 150 senses 206 a failure of at least a portion of autonomous vehicle 10, contingency plan process 150 may execute 208 initial failure contingency plan 154 in response to sensing the failure. As discussed above, initial failure contingency plan 154 may include: cease operation portion 156 and/or degraded operation portion 158.

Accordingly and in the event that the failure sensed 206 is a major failure that results in autonomous vehicle 10 no longer being capable of being safely operated, contingency plan process 150 may execute 208 cease operation portion 156 of initial failure contingency plan 154. For example, assume that autonomous vehicle 10 suffered a failure of its computer vision system, resulting in autonomous vehicle 10 no longer being able to “see” its surroundings. As such a failure results in autonomous vehicle 10 no longer being capable of being operated safely, this would be considered a “major failure” and contingency plan process 150 may execute 208 cease operation portion 156 of initial failure contingency plan 154 resulting in the orderly shutdown of autonomous vehicle 10.

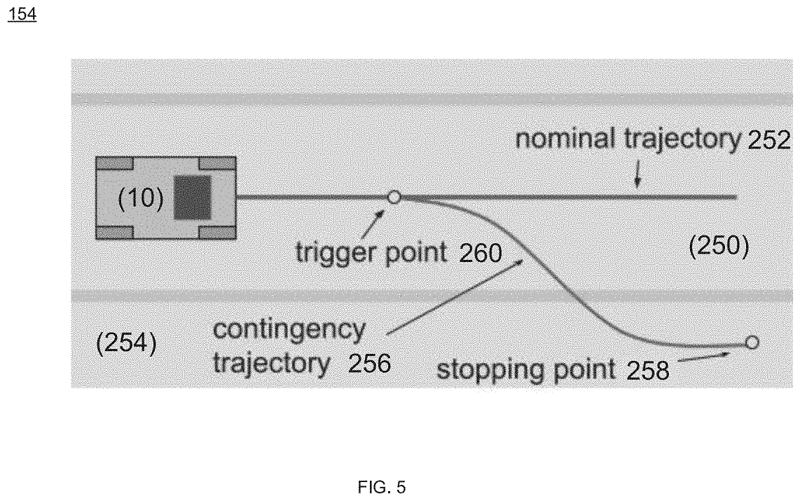

Referring also to FIG. 5, there is shown a visual representation of initial failure contingency plan 154. For example, assume that contingency plan process 150 monitors 202 the status of one or more sensors (e.g., sensors 12) included within autonomous vehicle 10 and determines that autonomous vehicle 10 is travelling in the right lane (e.g., lane 250) along normal trajectory 252 on its way to its intended destination. Further assume that contingency plan process 150 determines that shoulder 254 of the road on which autonomous vehicle 10 is travelling is currently empty. Accordingly, initial failure contingency plan 154 may define contingency trajectory 256 within initial failure contingency plan 154 that will allow for the orderly shutdown of autonomous vehicle 10 (stopping at stopping point 258) in the event of a major failure of autonomous vehicle 10.

Assume that (at trigger point 260) a major failure (e.g., the failure of its computer vision system) is sensed 206 that results in autonomous vehicle 10 no longer being capable of being safely operated. Accordingly, contingency plan process 150 may execute 208 cease operation portion 156 of initial failure contingency plan 154, resulting in autonomous vehicle 10 following contingency trajectory 256, resulting in autonomous vehicle 10 moving into shoulder 254 and ceasing operation at stopping point 258.

In the event that the failure sensed 206 is a minor failure that results in autonomous vehicle 10 being capable of continued degraded operation, contingency plan process 150 may execute 208 degraded operation portion 158 of initial failure contingency plan 154. For example, assume that autonomous vehicle 10 suffered a failure of its long-range LIDAR system, resulting in autonomous vehicle 10 no longer being able to “see” its surroundings great distances down the road but still being able to “see” its surroundings at closer distances. As such a failure results in autonomous vehicle 10 being capable of continued degraded operation, contingency plan process 150 may execute 208 degraded operation portion 158 of initial failure contingency plan 154, resulting in the degraded operation (e.g., maximum speed of 25 mph) of autonomous vehicle 10.

As would be expected, initial failure contingency plan 154 may no longer be valid after a very short period of time. For example, when autonomous vehicle 10 is travelling at 55 mph, autonomous vehicle 10 is travelling 80 feet per second. Accordingly, while shoulder 254 is clear for contingency trajectory 256 at the time that initial failure contingency plan 154 is calculated 204, initial failure contingency plan 154 may no longer be valid even one second later. Accordingly, contingency plan process 150 may repeatedly and iteratively update these failure contingency plans.

Accordingly, contingency plan process 150 may monitor 210 the operating environment of autonomous vehicle 10 to generate one or more updated usage values, wherein (as discussed above) contingency plan process 150 may monitor 212 the status of one or more sensors (e.g., sensors 12) included within autonomous vehicle 10 to generate the one or more updated usage values (e.g., sensor data 18). Contingency plan process 150 may calculate 214 updated failure contingency plan 160 based, at least in part, upon the one or more updated usage values (e.g., sensor data 18). As discussed above, contingency plan process 150 may monitor 210 sensor data 18 so that contingency plan process 150 is aware of the surrounding of autonomous vehicle 10, thus allowing for the calculation 214 of updated failure contingency plan 160 based, at least in part, upon sensor data 18.

As with initial failure contingency plan 154, updated failure contingency plan 160 may include one or more of: cease operation portion 162 configured to provide an orderly shutdown of autonomous vehicle 10 when the failure sensed is a major failure; and degraded operation portion 164 configured to allow degraded operation of autonomous vehicle 10 when the failure sensed is a minor failure.

As discussed above, failure contingency plans are temporal in nature and may no longer be valid after a very short period of time. Accordingly and when monitoring 210 the operating environment of autonomous vehicle 10 to generate one or more updated usage values (e.g., sensor data 18), contingency plan process 150 may iteratively monitor 216, at defined intervals, the operating environment of autonomous vehicle 10 to iteratively generate one or more updated usage values (e.g., sensor data 18). For example, contingency plan process 150 may iteratively monitor 216 the operating environment of autonomous vehicle 10 to iteratively generate sensor data 18 every e.g., 10 milliseconds. As would be expected, by gathering sensor data 18 more frequently, the more accurate and current the resulting failure contingency plans will be.

Further and when calculating 214 updated failure contingency plan 160 based, at least in part, upon the one or more updated usage values (e.g., sensor data 18), contingency plan process 150 may iteratively calculate 218, at defined intervals, updated failure contingency plan 160 based, at least in part, upon the one or more updated usage values (e.g., sensor data 18). For example, if contingency plan process 150 iteratively monitors 216 the operating environment of autonomous vehicle 10 to iteratively generate sensor data 18 every e.g., 10 milliseconds, contingency plan process 150 may iteratively calculate 218 an updated failure contingency plan (e.g., updated failure contingency plan 160) based, at least in part, upon sensor data 18 every 10 milliseconds. As would be expected, by gathering sensor data 18 and generating updated failure contingency plans more frequently, the more accurate and current the resulting failure contingency plans will be.

In the event that contingency plan process 150 senses 220 a failure of at least a portion of autonomous vehicle 10, contingency plan process 150 may execute 222 updated failure contingency plan 160 in response to sensing the failure.

As discussed above, assume that autonomous vehicle 10 suffered a failure of its computer vision system, resulting in autonomous vehicle 10 no longer being able to “see” its surroundings. As such a failure results in autonomous vehicle 10 no longer being capable of being operated safely, this would be considered a “major failure” and contingency plan process 150 may execute 222 cease operation portion 162 of updated failure contingency plan 160 resulting in the orderly shutdown of autonomous vehicle 10. Further and in the event that the failure sensed 220 is a minor failure that results in autonomous vehicle 10 being capable of continued degraded operation, contingency plan process 150 may execute 222 degraded operation portion 164 of updated failure contingency plan 160.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
monitoring the operating environment of an autonomous vehicle to generate one or more initial usage values; and
calculating an initial failure contingency plan based, at least in part, upon the one or more initial usage values.

2. The computer-implemented method of claim 1 wherein monitoring the operating environment of an autonomous vehicle to generate one or more initial usage values includes:
monitoring the status of one or more sensors included within the autonomous vehicle to generate the one or more initial usage values.

3. The computer-implemented method of claim 1 further comprising:
sensing a failure of at least a portion of the autonomous vehicle; and
executing the initial failure contingency plan in response to sensing the failure.

4. The computer-implemented method of claim 3 wherein the initial failure contingency plan includes one or more of:
a cease operation portion configured to provide an orderly shutdown of the autonomous vehicle when the failure sensed is a major failure; and
a degraded operation portion configured to allow degraded operation of the autonomous vehicle when the failure sensed is a minor failure.

5. The computer-implemented method of claim 1 further comprising:
monitoring the operating environment of an autonomous vehicle to generate one or more updated usage values; and
calculating an updated failure contingency plan based, at least in part, upon the one or more updated usage values.

6. The computer-implemented method of claim 5 wherein monitoring the operating environment of an autonomous vehicle to generate one or more updated usage values includes:
monitoring the status of one or more sensors included within the autonomous vehicle to generate the one or more updated usage values.

7. The computer-implemented method of claim 5 further comprising:
sensing a failure of at least a portion of the autonomous vehicle; and
executing the updated failure contingency plan in response to sensing the failure.

8. The computer-implemented method of claim 7 wherein the updated failure contingency plan includes one or more of:
a cease operation portion configured to provide an orderly shutdown of the autonomous vehicle when the failure sensed is a major failure; and
a degraded operation portion configured to allow degraded operation of the autonomous vehicle when the failure sensed is a minor failure.

9. The computer-implemented method of claim 5 wherein monitoring the operating environment of an autonomous vehicle to generate one or more updated usage values includes:
iteratively monitoring, at defined intervals, the operating environment of an autonomous vehicle to iteratively generate one or more updated usage values.

10. The computer-implemented method of claim 9 wherein calculating an updated failure contingency plan based, at least in part, upon the one or more updated usage values includes:
iteratively calculating, at defined intervals, the updated failure contingency plan based, at least in part, upon the one or more updated usage values.

11. A computer program product residing on a computer readable medium having a plurality of instructions stored thereon which, when executed by a processor, cause the processor to perform operations comprising:
monitoring the operating environment of an autonomous vehicle to generate one or more initial usage values; and
calculating an initial failure contingency plan based, at least in part, upon the one or more initial usage values.

12. The computer program product of claim 12 wherein monitoring the operating environment of an autonomous vehicle to generate one or more initial usage values includes:
monitoring the status of one or more sensors included within the autonomous vehicle to generate the one or more initial usage values.

13. The computer program product of claim 11 further comprising:
sensing a failure of at least a portion of the autonomous vehicle; and
executing the initial failure contingency plan in response to sensing the failure.

14. The computer program product of claim 13 wherein the initial failure contingency plan includes one or more of:
a cease operation portion configured to provide an orderly shutdown of the autonomous vehicle when the failure sensed is a major failure; and
a degraded operation portion configured to allow degraded operation of the autonomous vehicle when the failure sensed is a minor failure.

15. The computer program product of claim 11 further comprising:
monitoring the operating environment of an autonomous vehicle to generate one or more updated usage values; and
calculating an updated failure contingency plan based, at least in part, upon the one or more updated usage values.

16. The computer program product of claim 15 wherein monitoring the operating environment of an autonomous vehicle to generate one or more updated usage values includes:
monitoring the status of one or more sensors included within the autonomous vehicle to generate the one or more updated usage values.

17. The computer program product of claim 15 further comprising:
sensing a failure of at least a portion of the autonomous vehicle; and
executing the updated failure contingency plan in response to sensing the failure.

18. The computer program product of claim 17 wherein the updated failure contingency plan includes one or more of:
a cease operation portion configured to provide an orderly shutdown of the autonomous vehicle when the failure sensed is a major failure; and
a degraded operation portion configured to allow degraded operation of the autonomous vehicle when the failure sensed is a minor failure.

19. The computer program product of claim 15 wherein monitoring the operating environment of an autonomous vehicle to generate one or more updated usage values includes:
iteratively monitoring, at defined intervals, the operating environment of an autonomous vehicle to iteratively generate one or more updated usage values.

20. The computer program product of claim 19 wherein calculating an updated failure contingency plan based, at least in part, upon the one or more updated usage values includes:
iteratively calculating, at defined intervals, the updated failure contingency plan based, at least in part, upon the one or more updated usage values.

21. A computing system including a processor and memory configured to perform operations comprising:
monitoring the operating environment of an autonomous vehicle to generate one or more initial usage values; and
calculating an initial failure contingency plan based, at least in part, upon the one or more initial usage values.

22. The computing system of claim 21 wherein monitoring the operating environment of an autonomous vehicle to generate one or more initial usage values includes:
monitoring the status of one or more sensors included within the autonomous vehicle to generate the one or more initial usage values.

23. The computing system of claim 21 further comprising:
sensing a failure of at least a portion of the autonomous vehicle; and
executing the initial failure contingency plan in response to sensing the failure.

24. The computing system of claim 23 wherein the initial failure contingency plan includes one or more of:
a cease operation portion configured to provide an orderly shutdown of the autonomous vehicle when the failure sensed is a major failure; and
a degraded operation portion configured to allow degraded operation of the autonomous vehicle when the failure sensed is a minor failure.

25. The computing system of claim 21 further comprising:
monitoring the operating environment of an autonomous vehicle to generate one or more updated usage values; and
calculating an updated failure contingency plan based, at least in part, upon the one or more updated usage values.

26. The computing system of claim 25 wherein monitoring the operating environment of an autonomous vehicle to generate one or more updated usage values includes:
monitoring the status of one or more sensors included within the autonomous vehicle to generate the one or more updated usage values.

27. The computing system of claim 25 further comprising:
sensing a failure of at least a portion of the autonomous vehicle; and
executing the updated failure contingency plan in response to sensing the failure.

28. The computing system of claim 27 wherein the updated failure contingency plan includes one or more of:
a cease operation portion configured to provide an orderly shutdown of the autonomous vehicle when the failure sensed is a major failure; and
a degraded operation portion configured to allow degraded operation of the autonomous vehicle when the failure sensed is a minor failure.

29. The computing system of claim 25 wherein monitoring the operating environment of an autonomous vehicle to generate one or more updated usage values includes:
iteratively monitoring, at defined intervals, the operating environment of an autonomous vehicle to iteratively generate one or more updated usage values.

30. The computing system of claim 29 wherein calculating an updated failure contingency plan based, at least in part, upon the one or more updated usage values includes:
iteratively calculating, at defined intervals, the updated failure contingency plan based, at least in part, upon the one or more updated usage values.
